(19) United States
(12) Patent Application Publication
(10) Pub. No.: US 2013/0042020 A1
(43) Pub. Date: Feb. 14, 2013

(54) Quick Network Path Discovery

(71) Applicants: Jerrold STIFFLER, Cary, NC (US); Raghavendra UPPALLI, Cary, NC (US); James Mark SHAW, Cary, NC (US)

(72) Inventors: Jerrold STIFFLER, Cary, NC (US); Raghavendra UPPALLI, Cary, NC (US); James Mark SHAW, Cary, NC (US)

(73) Assignee: OPNET Technologies, Inc., Bethesda, MD (US)

(21) Appl. No.: 13/568,988

(22) Filed: Aug. 7, 2012

Related U.S. Application Data
(60) Provisional application No. 61/521,833, filed on Aug. 10, 2011.

(51) Int. Cl. G06F 15/173

(52) U.S. Cl. 709/238

(57) ABSTRACT

Embodiments for quick network path discovery are provided. Embodiments may be used by a user (e.g., network administrator) in troubleshooting a performance/communication problem in the network. M an embodiment, path information, including Layer-3 and/or Layer-2 path information, can be requested between any pair of devices in the network and presented to the user. In an embodiment, path information is provided to the user in an iterative (or gradual) manner as soon as resolved. This allows the user quick access to path information, which both reduces troubleshooting time and enhances the user experience. In addition, in an embodiment, the path information may be provided without any live interaction with any device in the network.

### CROSS-REFERENCE TO RELATED APPLICATIONS

The present application claims the benefit of U.S. Provisional Patent Application No. 61/521,833, filed on Aug. 10, 2011, which is incorporated herein by reference in its entirety.

### BACKGROUND

1 Field of the Invention

The present disclosure relates generally to network path discovery.

2. Background Art

Networks are an essential component of any business today. As businesses deliver their applications over networks, the reliability and availability of the networks is paramount to the success of a business. At the same time, networks are increasingly evolving and becoming more complex and sophisticated. As such, the ability to troubleshoot a network problem quickly is very important.

Existing techniques for troubleshooting a network problem between a pair of devices operate by first determining a complete Layer-3 path between the pair of devices and then overlaying the Layer-3 path over a connected network model to determine a complete Layer-2 and Layer-3 path. A Layer-3 path consists of devices that only operate at the network layer of the Open Systems Interconnection (OSI) model. A consolidated Layer-2 and Layer-3 path contains all of the network and data link layer devices in the path.

One problem with existing techniques is that determining a complete Layer-3 path may take a significant amount of time to complete, especially in a large network. This can lead to loss of valuable time in troubleshooting and an unpleasant user experience.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an example network environment according to an embodiment.

FIG. 2 illustrates an example path discovery module according to an embodiment.

FIG, 3 illustrates an example process flowchart of a method of path discovery according to an embodiment,

FIG. 4 is an example embodiment that illustrates a step of determining default routers according to the process of FIG. 3.

FIG. 5 is an example embodiment that illustrates a step of determining connected devices according to the process of FIG. 3.

FIG, 6 is an example embodiment that illustrates a step of determining Layer-2 paths between default routers and connected devices according to the process of FIG. 3.

FIG. 7 is an example embodiment that illustrates a step of determining a Layer-3 path between default routers according to the process of FIG. 3.

FIG. 8 is an example embodiment that illustrates a step of determining a Layer-2 path between default routers according to the process of FIG. 3.

FIG. 9 illustrates an example computer system that can be used to implement aspects of embodiments.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

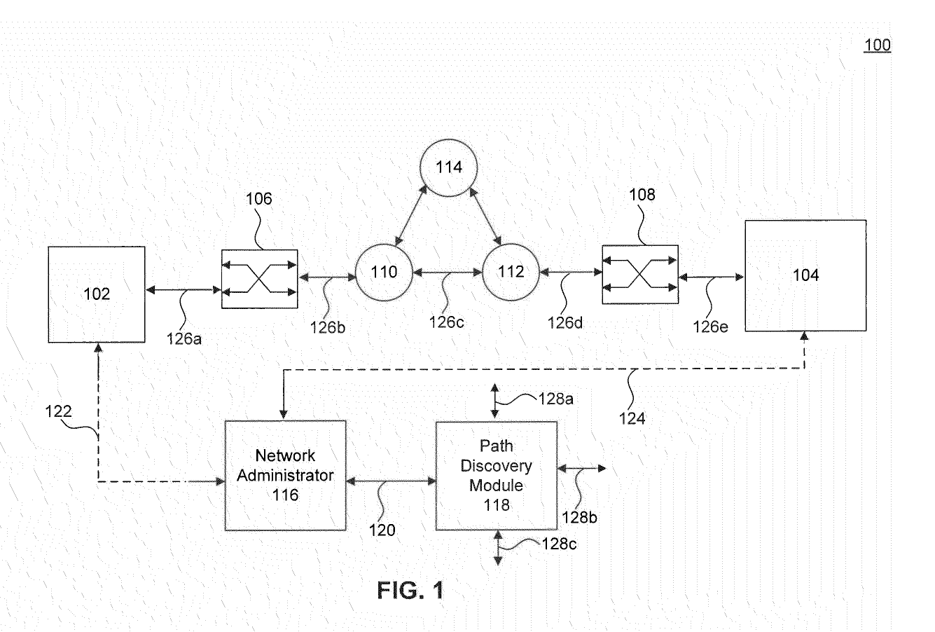

FIG. 1 illustrates an example network environment 100 according to an embodiment of the present disclosure. Example network environment 100 is provided for the purpose of illustration and is not limiting of embodiments of the present disclosure. As shown in FIG. 1, example network environment 100 includes a plurality of network nodes 102, 104, 106, 108, 110, 112, and 114, a network administrator 116, and a path discovery module 118. As would be understood by a person of skill in the art based on the teachings herein, example network environment 100 may include more or less network nodes and/or elements than shown in FIG. 1.

In an embodiment, network nodes 102 and 104 are in communication with each other. For example, network nodes 102 and 104 may be in communication to support a network application. The network application may be a client-server application or a peer-to-peer application. Communication between nodes 102 and 104 may be enabled by one or more intermediate nodes. For example, communication between nodes 102 and 104 may be enabled by nodes 106, 108, 110, and 112, which along with nodes 102 and 104 establish a communication path between nodes 102 and 104. In an embodiment, the communication path includes a plurality of connections 126a-e as shown in FIG. 1. Each connection 126a-e may include one or more data links and may include further network nodes.

The intermediate nodes between nodes 102 and 104 may include Layer-3 (L-3) and/or Layer-2 (L-2) devices. In the example of FIG. 1, nodes 110, 112, and 114 are L-3 devices, and nodes 106 and 108 are L-2 devices. L-3, or network layer, devices include devices such as routers and L-3 switches. L-3 devices perform packet routing based on maintained routing tables. Typically, a routing table at an L-3 device enables the device to map a packet's L-3 destination address to an outgoing interface on the device. In addition, L-3 devices may perform L-2 switching, as further described below. L-3 devices may further employ an L-3 to L-2 resolution protocol (e.g., Address Resolution Protocol (ARP)) to translate L-3 (e.g., IP) addresses to L-2 (e.g., Medium Access Protocol (MAC)) addresses.

L-2, or data link layer, devices include devices such as L-2 switches and bridges. L-2 devices implement frame switching, whereby a data frame received by an ingress interface (incoming data port) is switched for transmission by an egress interface (outgoing data port) based on an L-2 forwarding table. For example, L-2 switching may rely on a MAC forwarding table, which maps frame destination MAC addresses to outgoing data port numbers of the L-2 device. Typically, each ingress/egress interface has an associated MAC address.

In embodiments, each of network nodes 102, 104, 106, 108, 110, 112, and 114 may or may not be part of a managed network, which is managed by network administrator 116, for example. In the example of FIG. 1, nodes 102 and 104 are managed by network administrator 116 via connections 122 and 124, respectively. As such, network administrator 116 may have access privileges to nodes 102 and 104, which allow network administrator 116 to access, control, and execute network management processes from nodes 102 and 104. In contrast, network administrator 116 may not access unmanaged devices in example network environment 100. For example, node 114 may not be managed by network administrator 116. However, network administrator 116 may detect unmanaged node 114 based on operational data (e.g., data traffic, routing information, switching information, etc.) collected from managed nodes, such as nodes 102 and 104, for example.

In addition to network management, network administrator 116 may provide performance-metrics and troubleshooting functions. For example, network administrator 116 may monitor and collect network application performance data between nodes 102 and 104. Network administrator 116 may also troubleshoot performance and/or communication problems associated with managed or unmanaged devices in the network.

In embodiments, network administrator 116 may be alerted to a potential performance/communication problem by a managed device or may automatically detect a potential problem from collected performance-related data. For example, network administrator 116 may be alerted by node 102 to a high communication delay between nodes 102 and 104. Network administrator 116 may then analyze the cause of the delay by performing various troubleshooting functions. Network administrator 116 may also analyze performance/communication problems not directly involving managed devices.

In embodiments, network administrator 116 uses path discovery module 118 in troubleshooting a performance/communication problem in example network environment 100. Specifically, network administrator 116 may communicate with path discovery module 118 to request and obtain path information between any pair of devices in example network environment 100. The pair of devices may be directly or indirectly involved with the performance/communication problem. For example, the performance/communication problem may be related to a network application executing at nodes 102 and 104. The pair of devices may thus be nodes 102 and 104 or any other pair of nodes directly or indirectly impacting or impacted by the performance/communication problem.

In embodiments, as further described below, the path information may include L-3 and/or L-2 path information between the pair of devices, and may be provided to network administrator 116 in an iterative (or gradual) manner as soon as resolved by path discovery module 118. This allows network administrator 116 quick access to path information, which both reduces troubleshooting time and enhances the network administrator user experience. In addition, as further described below, the path information may be provided without any live interaction with the devices involved by the path information.

In an embodiment, as shown in FIG. 1, path discovery module 118 is located at a server remote from network administrator 116, and network administrator 116 communicates with path discovery module 118 via a connection 120. In another embodiment, path discovery module 118 is a sub-module of network administrator 116, located within network administrator 116.

Path discovery module 118 may be part of the network managed by network administrator node 116 or may belong to a third-party network. In an embodiment, path discovery module 118 includes a plurality of network interfaces 128a-c that connect it to managed and/or unmanaged devices of example network environment 100.

In embodiments, path discovery module 118 may include IP detection capability and/or connectivity inference capability, which can be relied on to provide path information to network administrator 116. IP detection capability allows path discovery module 118 to discover unmanaged L-3 devices in example network environment 100. In an embodiment, the IP detection capability is enabled by periodic collection of operational data from managed devices. The operational data generally includes IP addresses of unmanaged L-3 devices in the network, which may not be known and may thus be discovered by path discovery module 118. In an embodiment, the operational data is provided to path discovery module 118 by network administrator 116, which has access to the operational data by virtue of its access privileges to managed devices. Alternatively, path discovery module 118 may be part of the managed network and may periodically access the managed devices to obtain the operational data.

Connectivity inference capability may include connectivity inference between managed devices and between managed and discovered unmanaged devices. In an embodiment, path discovery module 118 may include an inference algorithm that runs periodically to infer connectivity between devices. In an embodiment, the inference algorithm may use operational data such as data traffic and/or information obtained from routing tables, ARP tables, MAC forwarding tables, and/or neighbor discovery protocols running on the managed devices. When connectivity is inferred between two devices, the L-3 and/or L-2 devices that provide the connectivity between the two managed devices are determined.

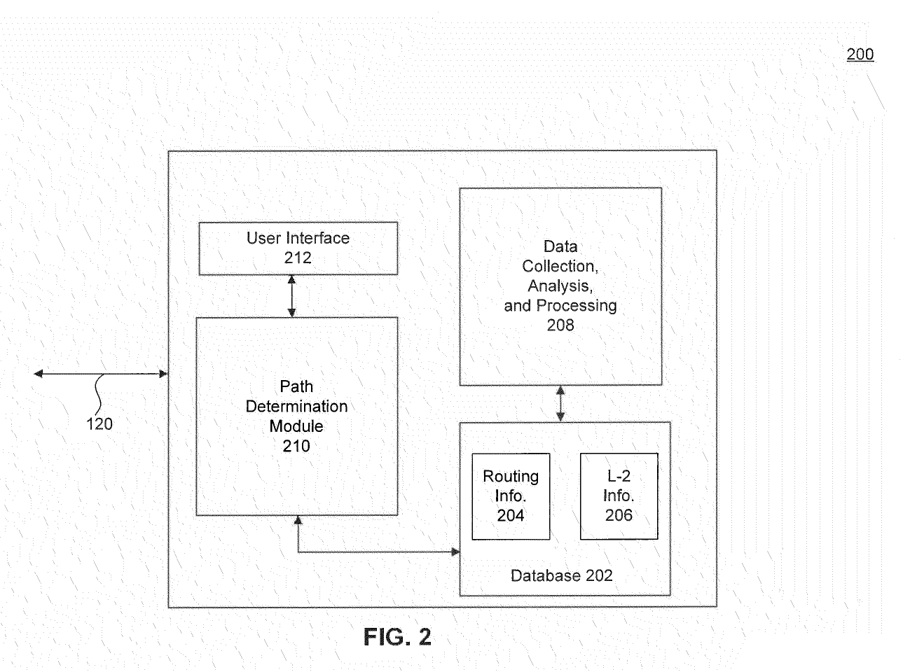

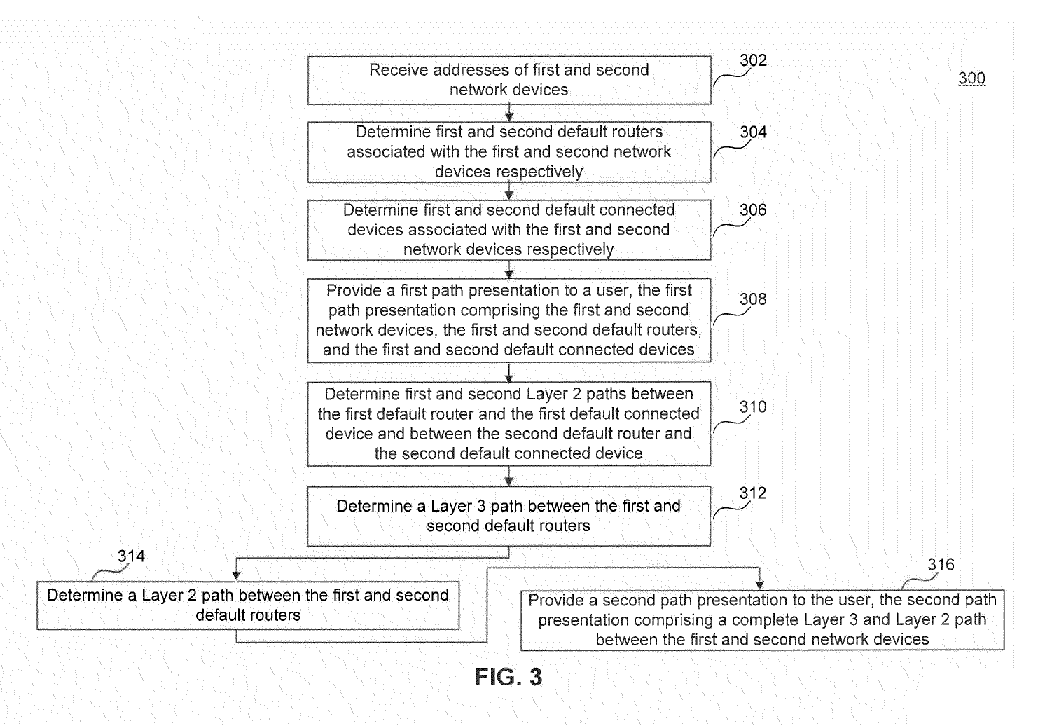

In embodiments, path discovery module 118 may be implemented using software, hardware, or a combination thereof. An example embodiment 200 of path discovery module 118 is provided in FIG. 2. As shown in FIG. 2, example path discovery module 200 includes a database 202, a data collection, analysis, and processing module 208, a path determination module 210, and a user interface 212. Example path discovery module 200 is provided for the purpose of illustration and is not limiting of embodiments of the present disclosure.

Data collection, analysis, and processing module 208 is configured to collect operational data periodically from the network environment. As mentioned above, the data may be collected by accessing managed devices and/or from a network administrator that has access to managed devices. Operational data may include data traffic and information obtained from routing tables, ARP tables, MAC forwarding tables, and/or neighbor discovery protocols running on the managed devices.

In an embodiment, module 208 may include logic to analyze the collected data to execute, for example, the above described IP detection and/or connectivity inference algorithms. Module 208 may also include logic to process the analyzed data in order to store it in database 202 in a format useable by path determination module 210. For example, in an embodiment, module 208 may process the analyzed data to generate a routing information database 204 and an L-2 information database 206, which are stored in database 202.

Routing information database 204 may include information about managed/unmanaged L-3 devices, routing tables at L-3 devices, and known L-3 paths between L-3 devices in the network environment. L-2 information database 206 may include information about managed/unmanaged L-2 devices, L-2 (e.g., MAC) forwarding tables, L-3 to L-2 translation tables (e.g., ARP tables), and known L-2 paths between L-2 devices in the network. Other types of database may also be generated, including for example L-3 and/or L-2 network topology databases. Topology databases may be generated using the connectivity inference algorithms.

Path determination module 210 is configured to communicate with user interface 212. In an embodiment, path determination module 210 is configured to receive a path request from user interface 212 and to provide path information, as specified in the path request, to user interface 212. The path request identifies a pair of devices for which path information is desired. The devices may be directly or indirectly involved with a performance/communication problem being troubleshot by a network administrator, for example. In embodiments, the devices may be identified by IP address and/or by MAC address in a path request. The path information desired may be identified as L-3 and/or L-2 in the path request.

In an embodiment, upon receiving a path request from user interface 212, path determination module 210 is configured to access and retrieve information from database 202 in order to resolve/determine the desired path information between the devices specified in the path request. The desired path information may be resolved partially or in its entirety based on information presently available in database 202. In an embodiment, the desired path information may be determined iteratively as the necessary information becomes available in database 202, and may thus be presented to the user in a gradual manner. As the desired path information is being resolved, path determination module 210 communicates the path information to user interface 212 for communication and presentation to the user.

User interface 212 allows path discovery module 200 to communicate with a user, such as network administrator 116, for example. In an embodiment, path discovery module 200 is located at a server remote from the user, and communication between the user and path discovery module 200 is done via connection 120. In another embodiment, path discovery module 200 is integrated within the user terminal and communication is done via internal processes.

In an embodiment, user interface 212 provides the user (e.g., network administrator) with an interface to submit a path request and to receive path information between any pair of devices in the network environment. In another embodiment, the path request may be generated automatically (e.g., following an application user reporting a problem with the application via a trouble ticketing system) and forwarded to path discovery module 200 without the user (e.g., network administrator) having to submit the path request. As mentioned above, the path request may identify the devices by IP and/or MAC address and the desired path information as L-3 and/or L-2. Upon receiving a path request, user interface 212 forwards the path request to path determination module 210. Path determination module 210 operates as described above and returns path information to user interface 212, which communicates the path information to the user,

In an embodiment, the path information includes L-3 and/or L-2 path information between the pair of devices identified in the path request, and is provided to the user in an iterative (or gradual) manner by user interface 212. In an embodiment, the path information is provided to the user in a user-friendly graphical display.

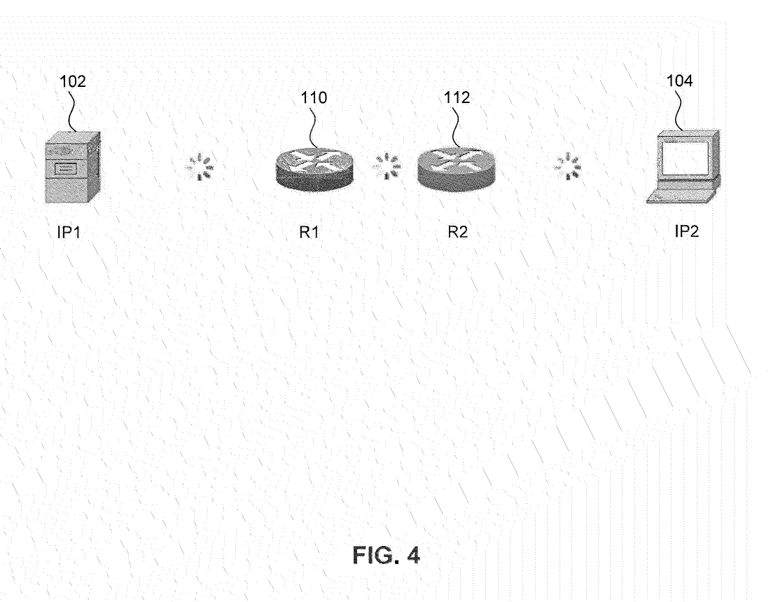

An example process 300 depicting a method of path discovery according to an embodiment of the present disclosure is provided in FIG. 3. Example process 300 may be performed by path discovery module 118 or 200 described above. For the purpose of illustration, example process 300 is described below with reference to FIGS. 4-8, which illustrate the process of path discovery with reference to example network environment 100 described above in FIG. 1. Specifically, FIGS. 4-8 illustrate process 300 performed to obtain path information between network nodes 102 and 104 of network environment 100.

As shown in FIG. 3, example process 300 includes steps 302, 304, 306, 308, 310, 312, 314, and 316. In embodiments, one or more of the steps may be non-operational or optional depending on the actual network environment.

Example process 300 begins in step 302, which includes receiving addresses of first and second network devices. Step 302 may be performed by user interface 212, for example. According to embodiments, the first and second network devices may be managed and/or unmanaged devices in the network environment. The addresses of the first and second network devices may include IP and/or MAC addresses and may be submitted to user interface 212 in a path request.

In an embodiment, step 302 may further include receiving desired path information (e.g., L-3 and/or L-2) between the first and second network devices. Alternatively, the desired path information is not specified and is assumed to include L-3 path information only, L-2 path information only, or both L-3 and L-2 path information.

Subsequently, in step 304, process 300 includes determining first and second default routers associated with the first and second network devices, respectively. In some embodiments, step 304 may result in multiple default routers being determined per network device. As such, process 300 may select one of the multiple default routers (e.g., based on some defined criteria) and proceed as further described below. Alternatively, process 300 may proceed in parallel instances for some or all of the multiple default routers, resulting in multiple paths being discovered at the end of process 300.

Step 304 is illustrated in FIG. 4 with respect to example network environment 100. As shown in FIG. 4, after receiving a pair of IP addresses (IP1 and IP2) identifying network devices 102 and 104 respectively, step 304 includes determining routers R1 110 and R2 112, where R1 110 is the default router for network device 102 and R2 112 is the default router for network device 104.

Step 304 may be performed by path determination module 210. In an embodiment, step 304 includes checking available L-3 to L-2 translation (e.g., ARP) tables in database 202 to determine an L-3 device with an entry for network device 102 or 104. As mentioned above, the L-3 to L-2 translation tables may be collected periodically by data collection, analysis, and processing module 208 and stored in database 202. The L-3 to L-2 tables may belong to managed L-3 devices of the network environment. L-3 devices that are actively communicating with network device 102 or 104 will have an entry for network device 102 or 104 in their translation tables. For example, in the case of ARP tables, routers R1 110 and R2 112 will include the IP addresses of network devices 102 and 104, respectively, in their ARP tables.

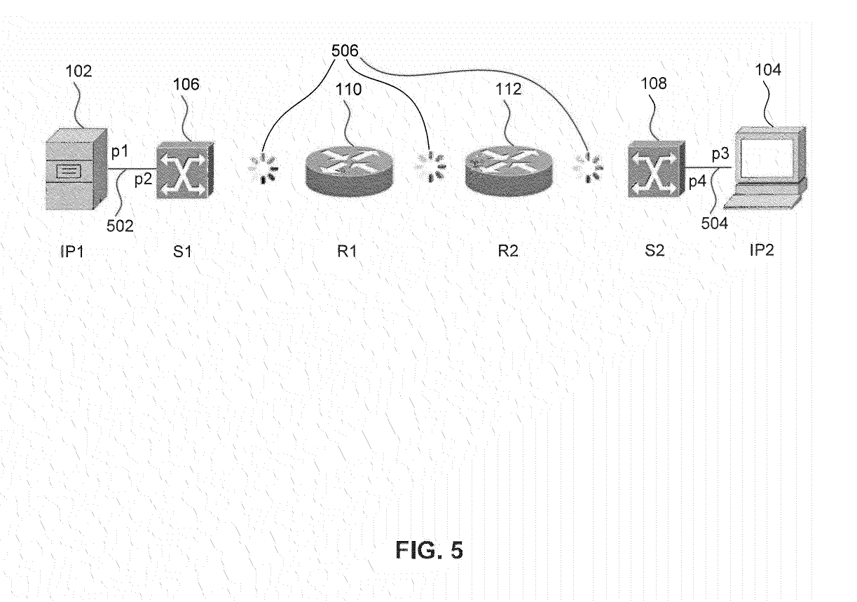

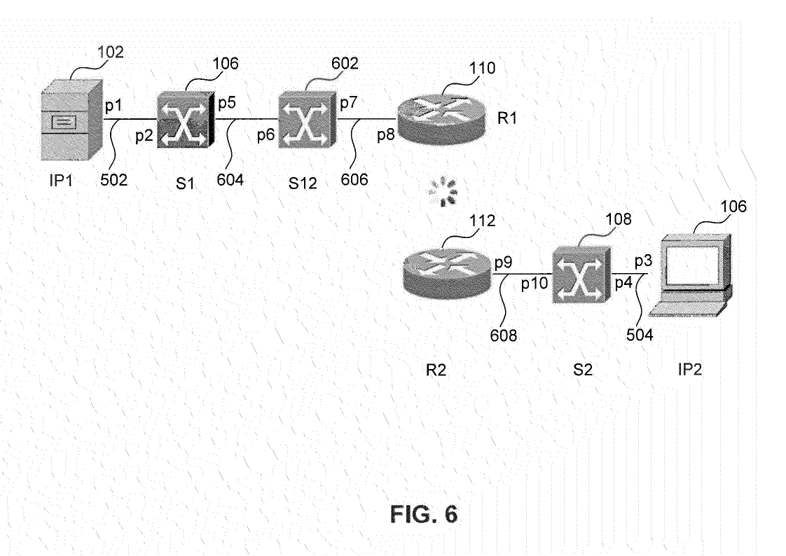

Process 300 may then proceed to step 306, which includes determining first and second connected devices associated with the first and second network devices, respectively. Step 306 is illustrated in FIG. 5 with respect to example network environment 100. As shown in FIG. 5, step 306 includes determining switches S1 106 and S2 108, which are the default (directly) connected devices for network devices 102 and 104 respectively in example environment 100. In addition, step 306 includes identifying egress and ingress interfaces p1 and p2 along a link 502 that connects network device 102 and switch S1 106, and egress and ingress interfaces p3 and p4 along a link 504 that connects network device 104 and switch S2 108. It is noted that, depending on the network topology, step 306 may or may not result in additional connected devices being identified.

Step 306 may be performed by path determination module 210. In an embodiment, step 306 is performed by checking an L-2 forwarding table and/or a topology database present in database 202. The L-2 topology database may be generated by the connectivity inference algorithms that run periodically in data collection, analysis, and processing module 208.

Process 300 may then proceed to step 308, which includes providing a first path presentation to a user. The user may be a network administrator as described above. Step 308 is optional and may be performed by user interface 212. In an embodiment, step 308 may include presenting the user with a graphical path depiction as shown in FIG. 5, for example. The graphical path depiction may include network devices 102 and 104, routers 110 and 112, and switches 106 and 108, presented in order according to the path between devices 102 and 104. Known egress and ingress interfaces may also be presented as shown in FIG. 5. The segments of the path that are still being resolved are indicated with an animated (e.g., spinning) icon 506, which signals that the system is working on determining more accurate path information for those segments.

Subsequently, process 300 proceeds to step 310, which includes determining first and second L-2 paths between the first default router and the first connected device and between the second default router and the second connected device. Step 310 is illustrated in FIG. 6 with respect to example network environment 100. As shown in FIG. 6, step 310 includes determining the L-2 path between switch S1 106 and router R1 110 and the L-2 path between switch S2 108 and router R2 112. This includes identifying switch S12 602, which is directly connected to switch Si 106 and to router R1 110. In addition, this includes identifying egress and ingress interfaces p5 and p6 along a link 604 that connects switch S1 106 and switch S12 602, and egress and ingress interfaces p7 and p8 along a link 606 that connects switch S12 602 and router R1 110.

Step 310 may be performed by path determination module 210. In an embodiment, step 310 includes determining the MAC addresses of the facing interfaces of network device 102 and router R1 110, namely egress interface p1 of network device 102 and ingress interface p8 of router R1 110, and then “walking” the L-2 path between the two facing interfaces. In an embodiment, this includes, at network device 102, traversing link 502 to reach switch S1 106. At switch S1 106, a MAC forwarding table may be used to determine the egress interface (e.g., p5) that corresponds to the MAC address of ingress interface p8 of router R1 110. The incident link (e.g., link 604) on the determined egress interface is then traversed to discover switch S12 602. The same step is repeated at switch S12 602 to determine the egress interface (e.g., p7) that corresponds to the MAC address of ingress interface p8 of router R1 110. The incident link (e.g., link 606) on the determined egress interface is then traversed to reach router R1 110.

Similar steps are performed to determine the L-2 path between switch S2 108 and router R2 112 to identify egress interface p10, ingress interface p9, and link 608 connecting switch S2 108 and router R2 112. In embodiments, the links used for traversals in step 310 are kept up-to-date by a periodic maintenance process performed by module 208.

Steps 310 and 306 combined are equivalent to determining the L-2 paths between network devices 102 and 104 and their respective default routers 110 and 112. At the end of step 310, the complete connectivity (e.g., L-3 and L-2 path) between network devices 102 and 104 and their respective default routers 110 and 112 is determined. The result of step 310 may be provided in a path presentation to the user by user interface 212, similar to step 308 described above. This path presentation gives the user a valuable head start to begin investigating any potential problem while more accurate path information is being determined.

It is noted that steps 302-310 are typically performed very quickly since they do not involve any on-the-fly interaction with devices. In some cases, the result of step 310 may be the complete path between the network devices of interest. As such, the problem can be fully investigated after step 310. In other cases, the result of step 310 does not include the complete path but may be sufficient to diagnose the problem (e.g., if the problem device is in the path identified thus far). Thus, presenting the result of step 310 to the user could save some valuable troubleshooting time in many cases.

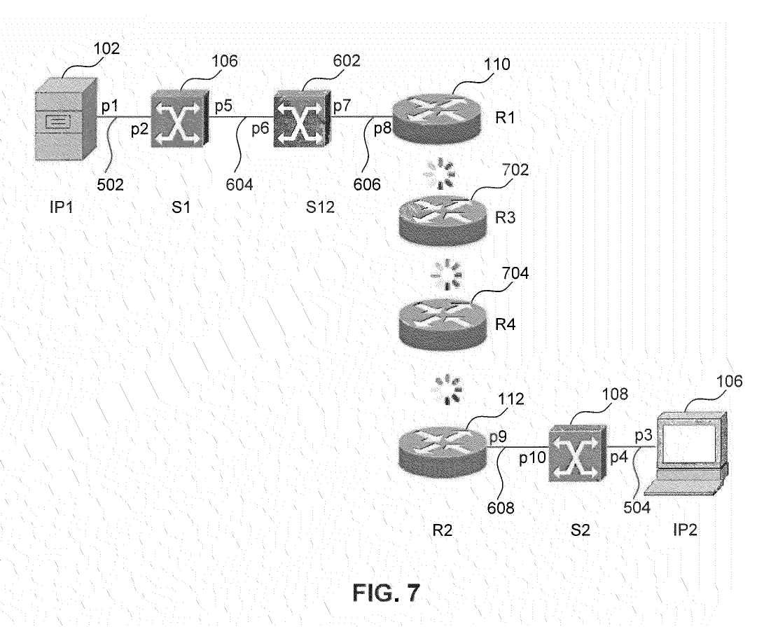

Process 300 then proceeds to step 312, which includes determining an L-3 path between the first and second default routers. Step 312 is illustrated in FIG. 7 with respect to example network environment 100. As shown in FIG. 7, step 312 includes determining the L-3 path between router R1 110 and router R2 112. This includes identifying L-3 devices, such as routers R3 702 and R4 704, located between router R1 110 and router R2 112.

Step 312 may be performed by path determination module 210. In embodiments, step 312 may be performed after step 310 as shown in FIG. 3, concurrently with any of steps 306, 308, and 310, or as soon as the first and second default routers have been determined in step 304. Performing step 310 immediately after step 304 reduces the processing time of process 300. If the first and second default routers are direct L-3 neighbors, however, step 312 is non-operational.

In an embodiment, step 312 is performed by accessing (logging into) router R1 110 (or R2 112) and running a command such as “traceroute” to router R2 112 (R1 110). A “traceroute” or “tracepath” command may be configured to cause each node that receives the command to respond to the sender, even if that node is not the intended recipient of the command. The response may be a notification of receiving the command, or a notification of forwarding the command, or a combination of such or similar notifications. In this manner, each node that passes the command to a next hop node along the path to the intended recipient notifies the sender that it received the command. As such, the sender can calculate the complete path to the intended recipient,

In another embodiment, if the routing tables of all L-3 devices in the path between the first and second default routers are available (e.g., an the L-3 devices are managed devices), the path can be determined by “walking” the routing tables to determine the L-3 path between the first and second default routers. For example, referring to FIG. 7, this may be performed, starting from router R1 110 (or router R2 112), by looking up in the routing table the next hop L-3 device for router R2 112 (router R1 110) and traversing the corresponding link to the next hop L-3 device. The same step is repeated at each L-3 node in the path until router R2 112 is reached.

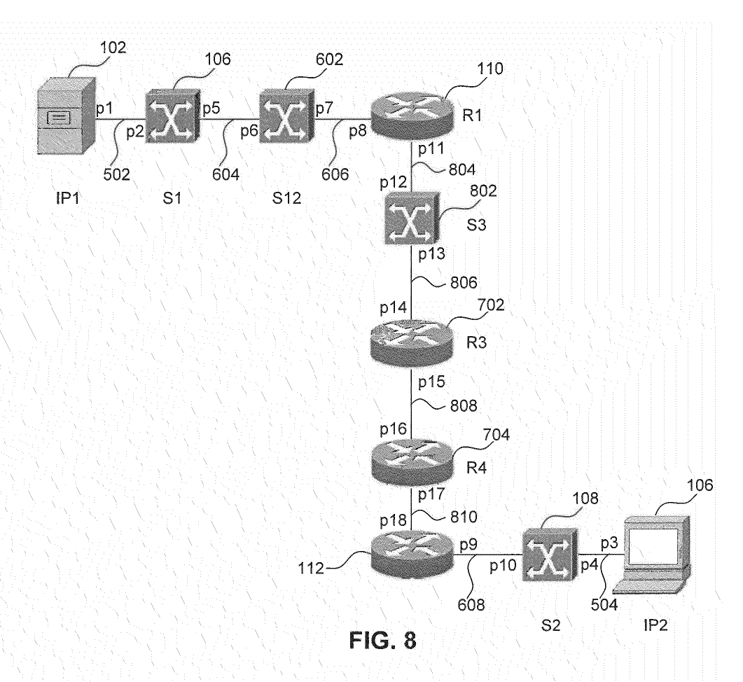

After step 312, process 300 proceeds to step 314, which includes determining an L-2 path between the first and second default routers; or more specifically, between the L-3 devices determined in step 312. Step 314 is illustrated in FIG. 8 with respect to example network environment 100. As shown in FIG. 8, step 314 includes determining the L-2 path between router R1 110 and router R2 112. This includes identifying L-2 switch S3 802 between routers R1 110 and R3 702, egress and ingress interfaces p11 and p12 along a link 804 that connects router R1 110 and switch S3 802, egress and ingress interfaces p13 and p14 along a link 806 that connects switch S3 802 and router R3 702, egress and ingress interfaces p15 and p16 along a link 808 that connects routers R3 702 and R4 704, and egress and ingress interfaces p17 and p18 along a link 810 that connects routers R4 704 and R2 112. Thus, the end result is a complete L-2 path between routers R1 110 and R2 112.

Step 314 may be performed by path determination module 210. In an embodiment, step 314 is performed by applying the same or a similar process as described above in step 306 for each L-3 segment along the path between routers R1 110 and R2 112. In the example of FIG. 8, this includes L-3 segments R1-R3, R3-R4, and R4-R2. If no additional L-3 devices are present between routers R1 110 and R2 112, then step 314 involves just one segment, R1-R2.

Process 300 may terminate in step 316, which includes providing a second path presentation to the user, including a complete L-3 and L-2 path between the first and second network devices. Step 316 may be performed by user interface 212. In an embodiment, step 316 may include presenting the user with a graphical path depiction as shown in FIG. 8, for example.

In an embodiment, when an unmanaged device is identified in the path in process 300, an indication to that effect is provided by inserting (or displaying) an “unknown device” in the path. An L-2 unmanaged device may be detected when looking up a segment destination in a MAC forwarding table or example, if a preceding device in the path identifies a certain port as the egress port and if that port happens to be unconnected in the topology database, then the next device along the identified egress port is unmanaged. An L-3 unmanaged device may be detected when searching for IP addresses reported in an L-3 path (e.g., from a traceroute command). If an IP address does not belong to any managed device, then the device identified by the IP address is unmanaged. Identification of unmanaged devices is important for the user (e.g., network administrator) to determine if a potential problem is inside/outside the user's domain and if coordination with other users may be needed to resolve the problem.

As described above, in an embodiment, no on-demand or live interaction with any device is needed to perform process 300, which makes the process very quick to execute and present results to the user. Additionally, some of the steps of process 300 may be performed simultaneously, in an embodiment, further speeding up the process. Results may be presented iteratively to the user as the complete path information is being resolved. For example, a path presentation or update may be provided to the user following every step in process 300 in which additional path information is identified. This gives the user a valuable head start to begin investigating any potential problem while more accurate path information is being determined.

Embodiments of the present disclosure may be used in conjunction with the methods and systems described in U.S. patent application Ser. Nos. 12/900,348 and 12/900,357, filed Oct. 7, 2010, entitled “Network Path Discovery and Analysis,” both of which are incorporated herein by reference in their entireties.

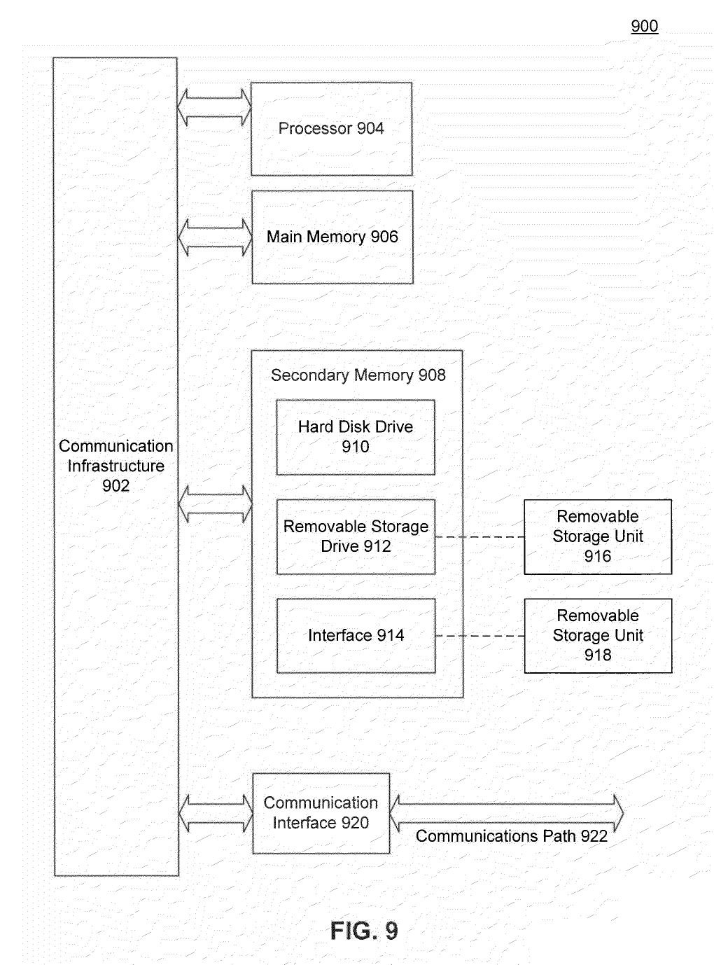

Embodiments of the present disclosure can be implemented in hardware, software or as a combination of software and hardware. Consequently, embodiments of the disclosure may be implemented in the environment of a computer system or other processing system. An example of such a computer system 900 is shown in FIG. 9. Embodiments described in FIGS. 1 and 2 may execute on one or more computer systems 900. Furthermore, each of the steps of the processes depicted in FIGS. 3-8 can be implemented on one or more computer systems 900.

Computer system 900 includes one or more processors, such as processor 904. Processor 904 can be a special purpose or a general purpose digital signal processor. Processor 904 is connected to a communication infrastructure 902 (for example, a bus or network). Various software implementations are described in terms of this exemplary computer system. After reading this description, it will become apparent to a person skilled in the relevant art(s) how to implement the disclosure using other computer systems and/or computer architectures.

Computer system 900 also includes a main memory 906, preferably random access memory (RAM), and may also include a secondary memory 908. Secondary memory 908 may include, for example, a hard disk drive 910 and/or a removable storage drive 912, representing a floppy disk drive, a magnetic tape drive, an optical disk drive, or the like. Removable storage drive 912 reads from and/or writes to a removable storage unit 916 in a well-known manner. Removable storage unit 916 represents a floppy disk, magnetic tape, optical disk, or the like, which is read by and written to by removable storage drive 912. As will be appreciated by persons skilled in the relevant art(s), removable storage unit 916 includes a computer usable storage medium having stored therein computer software and/or data.

In alternative implementations, secondary memory 908 may include other similar means for allowing computer programs or other instructions to be loaded into computer system 900. Such means may include, for example, a removable storage unit 918 and an interface 914. Examples of such means may include a program cartridge and cartridge interface (such as that found in video game devices), a removable memory chip (such as an EPROM, or PROM) and associated socket, a thumb drive and USB port, and other removable storage units 918 and interfaces 914 which allow software and data to be transferred from removable storage unit 918 to computer system 900.

Computer system 900 may also include a communications interface 920. Communications interface 920 allows software and data to be transferred between computer system 900 and external devices. Examples of communications interface 920 may include a modem, a network interface (such as an Ethernet card), a communications port, a PCMCIA slot and card, etc. Software and data transferred via communications interface 920 are in the form of signals which may be electronic, electromagnetic, optical, or other signals capable of being received by communications interface 920. These signals are provided to communications interface 920 via a communications path 922. Communications path 922 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 916 and 918 or a hard disk installed in hard disk drive 910. These computer program products are means for providing software to computer system 900.

Computer programs (also called computer control logic) are stored in main memory 906 and/or secondary memory 908. Computer programs may also be received via communications interface 920. Such computer programs, when executed, enable the computer system 900 to implement the present disclosure as discussed herein. In particular, the computer programs, when executed, enable processor 904 to implement the processes of the present disclosure, such as any of the methods described herein. Accordingly, such computer programs represent controllers of the computer system 900. Where the disclosure is implemented using software, the software may be stored in a computer program product and loaded into computer system 900 using removable storage drive 912, interface 914, or communications interface 920.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to he understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, but should be defined only in accordance with the following claims and their equivalents.

What is claimed is:

1. A method for path discovery in a network, comprising:
receiving, by a path discovery module, addresses of first and second network devices;
determining, by the path discovery module, first and second default routers associated with the first and second network devices, respectively;
determining, by the path discovery module, a first Layer-2 (L-2) path between the first network device and the first default router and a second L-2 path between the second network device and the second default router;
determining, by the path discovery module, a Layer-3 (L-3) path between the first and second default routers; and
determining, by the path discovery module, an L-2 path between the first and second default routers.

2. The method of claim 1, wherein receiving the addresses of the first and second network devices comprises receiving at least one of Internet Protocol (IP) addresses and Medium Access Protocol (MAC) addresses of the first and second network devices.

3. The method of claim 1, wherein determining the first and second default routers comprises checking at least one L-3 to L-2 translation table to determine an L-3 device with an entry for at least one of the first and second network devices.

4. The method of claim 1, wherein determining the first L-2 path and the second L-2 path comprises determining first and second connected devices associated with the first and second network devices, respectively.

5. The method of claim 4, wherein determining the first L-2 path and the second L-2 path further comprises:
identifying first egress and ingress interfaces along a first link that connects the first network device and the first connected device; and
identifying second egress and ingress interfaces along a second link that connects the second network device and the second connected device.

6. The method of claim 4, wherein determining the first L-2 path and the second L-2 path further comprises:
determining a third L-2 path between the first default router and the first connected device and a fourth L-2 path between the second default router and the second connected device.

7. The method of claim 1, wherein determining the L-3 path between the first and second default routers comprises executing a trace command from the first default router to the second default router.

8. The method of claim 1, wherein determining the L-3 path between the first and second default routers comprises retrieving from a routing table at least one L-3 device on a path between the first and second default routers.

9. The method of claim 1, further comprising collecting operational data periodically from the network.

10. The method of claim 9, wherein the operational data comprises at least one of data traffic and information obtained from one or more of routing tables, translation tables, L-2 forwarding tables, and neighbor discovery protocols of devices in the network.

11. The method of claim 1, further comprising:
providing a first path presentation to a user, the first path presentation comprising the first L-2 path between the first network device and the first default router and the second L-2 path between the second network device and the second default router.

12. The method of claim 11, wherein the providing the first path presentation to the user comprises providing the first path presentation to the user before determining the L-3 path between the first and second default routers.

13. The method of claim 11, further comprising:
providing a second path presentation to the user, the second path presentation comprising the first path presentation and at least one of the L-3 path and the L-2 path between the first and second default routers.

14. The method of claim 11, further comprising:
providing a second path presentation to the user, the second path presentation comprising a complete L-3 and L-2 path between the first and second network devices.

15. A system for path discovery in a network, comprising:
a user interface configured to receive addresses of first and second network devices; and
a path determination module configured to:
determine first and second default routers associated with the first and second network devices, respectively;
determine a first Layer-2 (L-2) path between the first network device and the first default router and a second L-2 path between the second network device and the second default router;
determine a Layer-3 (L-3) path between the first and second default routers; and
determine by the path discovery module, an L-2 path between the first and second default routers.

16. The system of claim 15, further comprising:
a data collection, analysis, and processing module configured to collect operational data periodically from the network.

17. The system of claim 16, wherein the operational data comprises at least one of data traffic and information obtained from one or more of routing tables, translation tables, L-2 forwarding tables, and neighbor discovery protocols of devices in the network.

18. The system of claim 16, wherein the data collection, analysis, and processing module is further configured to execute at least one of an Internet Protocol (IP) detection algorithm and a connectivity inference algorithm based on the operational data.

19. The system of claim 18, further comprising a database, and wherein the data collection, analysis, and processing module is further configured to process the operational data and store the processed operational data in the database.

20. The system of claim 15, wherein the user interface is further configured to iteratively provide a user path information of a path between the first and second network devices.

21. The system of claim 20, wherein the user interface is further configured to provide the path information graphically.

22. A method for path discovery in a network, comprising:
receiving, by a path discovery module, addresses of first and second network devices;
determining, by the path discovery module, first and second default routers associated with the first and second network devices, respectively;
determining, by the path discovery module, first and second connected devices associated with the first and second network devices, respectively; and
providing a first path presentation to a user, the first path presentation comprising the first and second network devices, the first and second default routers, and the first and second connected devices.

23. The method of claim 22, further comprising:
determining a first Layer-2 (L-2) path between the first default router and the first connected device and a second L-2 path between the second default router and the second connected device;
determining an L-3 path between the first and second default routers; and
determining an L-2 path between the first and second default routers.

24. The method of claim 22, further comprising:
providing a second path presentation to the user, the second path presentation comprising a complete L-3 and L-2 path between the first and second network devices.

25. A non-transitory computer-readable storage medium having control logic recorded thereon that, when executed by a processor, causes the processor to perform a method for path discovery in a network, the method comprising:
receiving addresses of first and second network devices;
determining first and second default routers associated with the first and second network devices, respectively;
determining a first Layer-2 (L-2) path between the first network device and the first default router and a second L-2 path between the second network device and the second default router;
determining a Layer-3 (L-3) path between the first and second default routers; and
determining an L-2 path between the first and second default routers.

26. The non-transitory computer-readable storage medium of claim 25, wherein determining the first L-2 path and the second L-2 path comprises:
determining first and second connected devices associated with the first and second network devices, respectively; and
determining a third L-2 path between the first default router and the first connected device and a fourth L-2 path between the second default router and the second connected device.

27. The non-transitory computer-readable storage medium of claim 25, wherein the method further comprises:
providing a first path presentation to a user, the first path presentation comprising the first L-2 path between the first network device and the first default router and the second L-2 path between the second network device and the second default router; and
providing a second path presentation to the user, the second path presentation comprising the first path presentation and at least one of the L-3 path and the L-2 path between the first and second default routers.

28. The non-transitory computer-readable storage medium of claim 25, wherein the method further comprises:
providing a first path presentation to a user, the first path presentation comprising the first L-2 path between the first network device and the first default router and the second L-2 path between the second network device and the second default router; and
providing a second path presentation to the user, the second path presentation comprising a complete L-3 and L-2 path between the first and second network devices.
